(19) United States
(12) Patent Application Publication
(10) Pub. No.: US 2014/0380300 A1
(43) Pub. Date: Dec. 25, 2014

(54) DYNAMIC CONFIGURATION FRAMEWORK

(71) Applicant: Bank of America Corporation, Charlotte, NC (US)

(72) Inventors: John R. Sampson, Charlotte, NC (US); Thiruvadi Natarajan Sundaramoorthy, Chennai, Tamil Nadu (IN); Sajoo Thomas, Chennai, Tamil Nadu (IN); Raja Gottumukkala, Chennai (IN)

(21) Appl. No.: 13/927,038

(22) Filed: Jun. 25, 2013

(51) Int. Cl. G06F 9/445

(52) U.S. Cl. CPC G06F 8/60
USPC 717/174

(57) ABSTRACT

Methods, systems, and computer-readable media for deploying a software module in a dynamic configuration framework are presented. A system may be running a software service, such as a software service that abstracts or transforms requests such that the requests may be serviced by a web service. The system may receive a request to deploy a new software module. In response to the request, the system may retrieve a binary file from a database. The binary file may comprise, for example, a Java Archive (.jar) file. A real-time class loader may then be accessed, where the real-time class loader may be configured to deploy the retrieved binary file. The software module may then be deployed by the real-time class loader using the retrieved binary file. The deployment may be achieved without interrupting the software service being run on the system.

### BACKGROUND

Aspects of the disclosure relate to computer hardware and software. In particular, one or more aspects of the disclosure generally relate to computer hardware and software that can be used to provide a dynamic configuration framework.

Large companies have become more complex and include more moving parts. As a result, computing devices are being required to interact with more systems in order to accomplish their assigned functionality. For instance, a web service may receive requests from a number of different entities. Moreover, these entities may communicate using different protocols. As additional entities communicating in different protocols interact with the web service, additional software functionality may be necessary to service the new requests formatted according to new protocols. In addition, software updates often require server down time and other types of reset for updates to be implemented. Accordingly, there is a need for a way to deploy updated software functionality to a framework in an efficient manner.

### SUMMARY

Aspects of the disclosure provide various techniques that enable a dynamic configuration framework to deploy a software module.

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Methods, systems, and computer-readable media for deploying a software module in a dynamic configuration framework are described according to an embodiment. A system may be running a software service, such as a software service that abstracts or transforms requests such that the requests may be serviced by a web service. The system may receive a request to deploy a new software module. In response to the request, the system may retrieve a binary file from a database. The binary file may comprise, for example, a Java Archive (.jar) file. A real-time class loader may then be accessed, where the real-time class loader may be configured to deploy the retrieved binary file. The software module may then be deployed by the real-time class loader using the retrieved binary file. The deployment may be achieved without interrupting the software service being run on the system.

In an embodiment, the request may be received from an administrator interacting with a user interface. In another embodiment, the request may be received according to an automated process. For example, a system may receive a web service request formatted according to a first protocol. The system may determine that the adapters available cannot handle the first protocol. Based on this determination, a request may be sent for an adapter that can handle the first protocol.

In an embodiment, the deployed software module may comprise an adapter configured to abstract or transform web service requests received according to a first protocol. The adapter may receive a request formatted according to a first protocol and abstract or transform the request such that it is formatted according to a second protocol. The transformed or abstracted request may then be routed to a web service. A reply may be received from the web service, where the reply is formatted according to the second protocol. The reply may be abstracted or transformed such that it is formatted according to the first protocol. The abstracted or transformed reply may then be sent to a requesting computing device.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment according to an embodiment.

FIG. 1B illustrates another example operating environment according to an embodiment.

FIG. 2 illustrates an example dynamic configuration framework for deploying a software module according to an embodiment.

FIG. 3 illustrates an example process for deploying a software module in a dynamic configuration framework according to an embodiment.

FIG. 4 illustrates an example process for guaranteed delivery in a framework according to an embodiment.

### DETAILED DESCRIPTION

In the following description of various embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

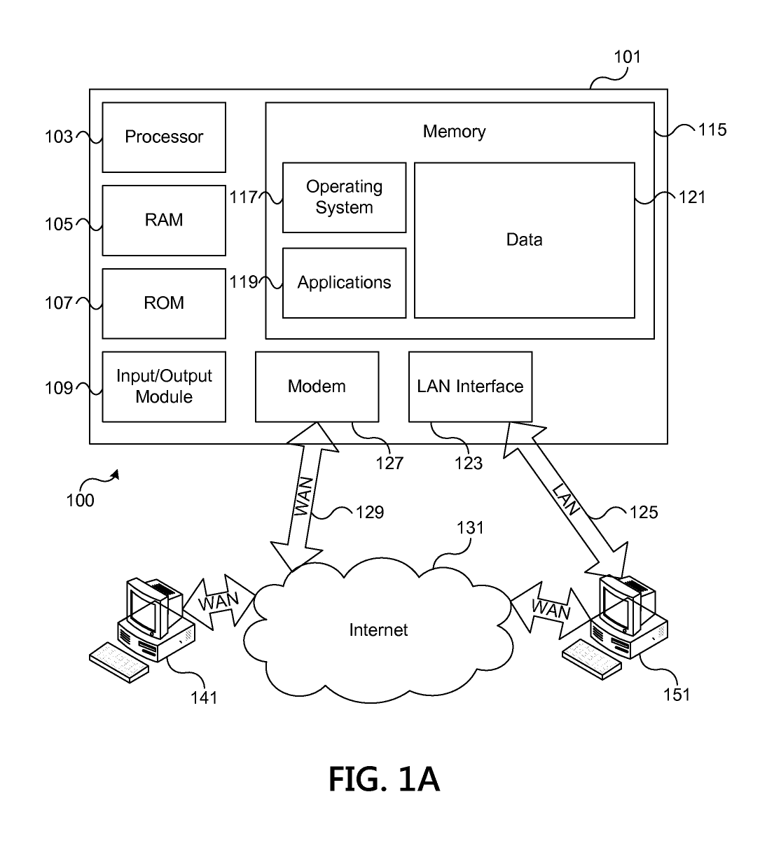

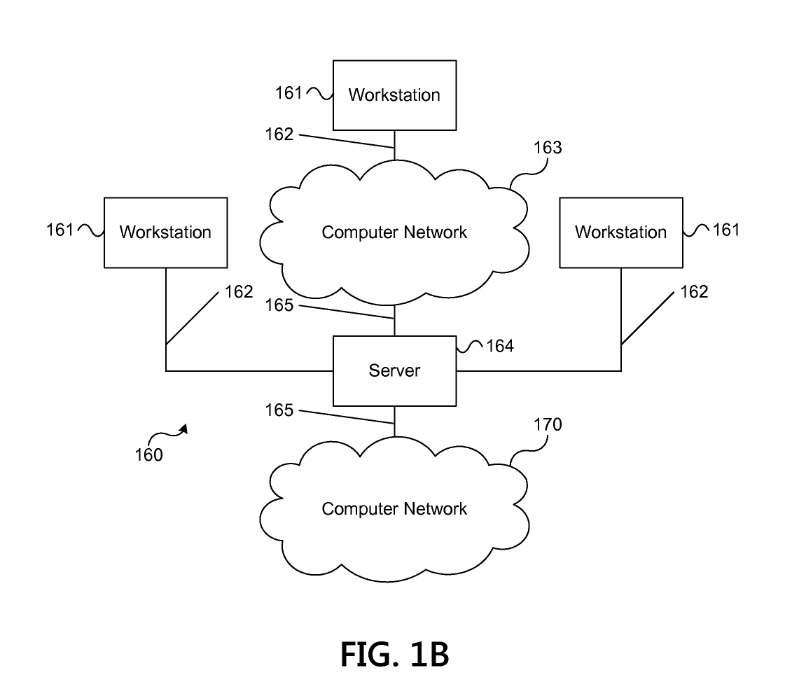

As noted above, certain embodiments are discussed herein that relate an open retirement account where a plurality of sources may deposit into the account and a display of the balance for the account may include pre-tax and post-tax portions. Before discussing these concepts in greater detail, however, an example of a computing device that can be used in implementing various aspects of the disclosure, as well as an example of an operating environment in which various embodiments can be implemented, will first be described with respect to FIGS. 1A and 1B.

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, and so on) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail.

In an embodiment, a system may service user requests from one or more computing device. For example, a system may include software services, such as a web service, and one or more computing devices may send requests to the web service. The requests may be formatted in accordance with a variety of protocols, such as message queue (MQ), common client interface (CCI), simple mail transfer protocol (SMTP), customer information control system (CICS), transfer control protocol (TCP), and the like. Accordingly, the system may include a transformation or abstraction layer to transform or abstract received requests. The transformed or abstracted request may be routed to the web service in a format such that the web service may comply with the request.

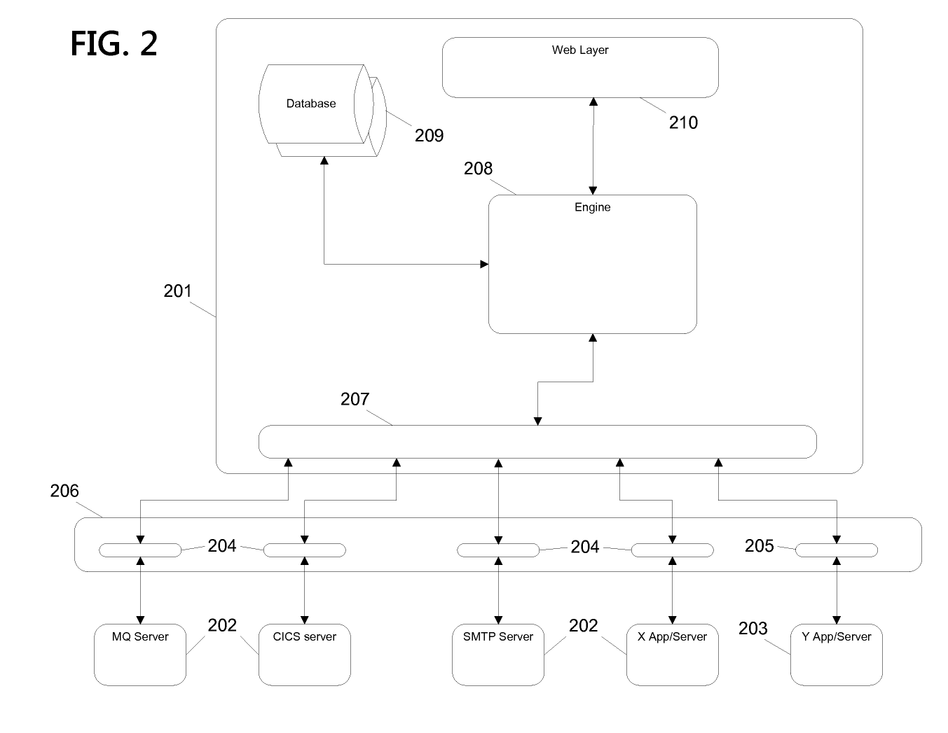

FIG. 2 illustrates an example dynamic configuration framework for deploying a software module in accordance with an embodiment. The framework of FIG. 2 include system 201, computing devices 202 that may comprise an MQ server, a CICS server, an SMTP server, and an X app server, computing device 203 that may comprise a Y app server, adapters 204 and 205, adapter layer 206, interface 207, engine 208, database 209 and web service 210. Computing devices 202 may submit requests to system 201 for web service 201. The requests may be formatted according to a variety of protocols according to the source of the request. For example, MQ server may use a message queue protocol, CICS server may use a CICS protocol, SMTP server may use a SMTP protocol, and X app server may use any other suitable protocol, such as TCP protocol. In an embodiment, computing devices 202 may comprise computing devices or servers that communicate using any suitable protocol.

Adapter layer 206 may comprise of adapters 204 that handle requests formatted according to particular protocols. Adapters 204 may transform or abstract the received requests such that they may be serviced by system 201. For example, adapters 204 may transform or abstract a request so that web service 210 may reply to the request. In an embodiment, transforming a received request may comprise reformatting the request, for example, to comply with a different protocol. In another embodiment, abstracting a request may comprise adding a layer, or wrapper, to the request such that the request is masked according to a different protocol. In an embodiment, adapters 204 may transform or abstract the received request such that the transformed or abstracted request is formatted according to a particular protocol, and web service 210 may be configured such that the web service may reply to a request formatted according to the particular protocol.

Each of adaptors 204 may handle request formatted according to a particular protocol. For example, one of adapters 204 may handle MQ formatted requests, one of adapters 204 may handle CICS formatted requests, one of adapters 204 may handle SMTP formatted requests, one of adapters 204 may handle TCP formatted requests, and so on. In an embodiment, adapters 204 my comprise adapters configured to handle requests of any suitable protocol. Interface 207 may communicate with adapters 204 such that the requests may be routed within system 201. For example, interface 207 may receive transformed or abstracted requests from adapters 204 and route them to engine 208.

In an embodiment, engine 208 may comprise a plurality of additional elements (not depicted) such that routing may be performed within system 201. For example, engine 208 may comprise one or more physical and/or virtual nodes used for routing, schedulers, message queues, listeners, a cache management layer, and any other suitable components. Engine 208 may route requests such that they may be serviced by system 201. In an embodiment, engine 208 may route requests to web service 210.

In an embodiment, web service 210 may reply to the request. For example, web service 210 may comprise an application programming interface (API), and the request may comprise an API call. Accordingly, web service 210 may reply to the API call. The reply may be routed through system 210, via engine 208 and interface 207 back to one of adapters 204. The reply may be routed to the particular one of adapter 204 that is configured to transform or abstract the reply back to an original protocol for the request. For example, a request may be generated at MQ server 202 and may be abstracted or transformed at one of adapters 204. The request may then be routed from one of adapters 204 to interface 207 and engine 208 until it is received at web service 210. Web service 210 may reply to the request and the reply may be routed back through engine 208 and interface 207 until it is received at one of adapters 204 configured to transform or abstract the reply into the MQ protocol. The reply may then be sent from one of adapters 204 to the MQ server 202.

In an embodiment, an adapter, such as adapter 205 may be deployed within the dynamic configuration framework illustrated in FIG. 2. A computing device, such as Y app server 203, may seek to send requests to system 201, as described above, but the computing device may communicate using a new protocol, where none of adapters 204 are configured to handle a request formatted according to the new protocol. Accordingly, adapter 205 may be deployed such that adapter 205 may handle request from Y app server 203 formatted according to the new protocol. The request may be routed and serviced similar to requests received at adapters 204, as described above.

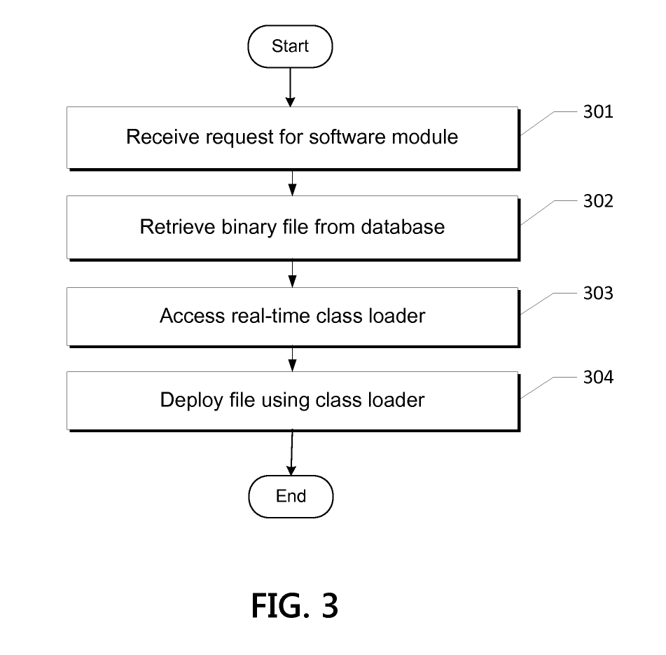

FIG. 3 illustrates an example method for deploying a software module in accordance with an embodiment. In an embodiment, system 201 may perform the process of FIG. 3. For example, the process may be used to deploy adapter 205. The process of FIG. 3 may start at step 301, where a request for a software module is received. For example, a user, such as a system administrator, may interact with a user interface and send a request for a software module. In an embodiment, a single click from a user interacting with a user interface may initiate the process of deploying the software module. In an embodiment, the received request may be a request for adapter 205. In another embodiment, the received request may be a request for any suitable software module.

In an embodiment, the request may be received according to an automated process. For example, system 201 may receive a web service request formatted according to a first protocol. The system may determine that the adapters available cannot handle the first protocol. Based on this determination, a request may be sent for an adapter that can handle a request formatted according to the first protocol. For example, system 201 may determine that adapters 204 cannot handle a request formatted according to the first protocol, and system 201 may request adapter 205.

The process of FIG. 3 may progress from step 301 to step 302, where a binary file is retrieved from a database. In an embodiment, database 209 may store binary java files configured for deployment in the framework of FIG. 2. For example, database 209 may store a Java Archive (.jar) file as a binary object, such as a binary large object (BLOB). In an embodiment, the .jar file may store class information configured to deploy the software module. For example, a .jar file stored in database 209 may store class information configured to deploy adapter 205.

In an embodiment, the retrieved binary java file may comprise a .far file. A .far file may be similar to a .jar file, however the .far file may include a unique deployment descriptor. For example, a .far file may comprise a deployment descriptor configured to deploy a software module with a framework, such as the framework illustrated in FIG. 2. In an alternative embodiment, the retrieved file may comprise a file similar to a .jar file that leverages a different web technology, such as a .NET technology, or may comprise any other suitable file.

The process of FIG. 3 may progress from step 302 to step 303, where a real-time class loader is accessed. A real-time class loader may be configured to deploy the retrieved binary file. For example, a real-time java class loader may be configured to deploy a retrieved .jar file, or .far file.

The process of FIG. 3 may progress from step 303 to step 304, where the retrieved file is deployed using the real-time class loader. For example, a retrieved .jar file may be deployed using a real-time java class loader such that a software module is deployed for use. In an embodiment, a retrieved .jar file may be deployed using a real-time java class loader such that adapter 205 is deployed. In this embodiment, once deployed, adapter 205 may receive requests from Y app server 203 and may route the requests, and any subsequent replies, as described above.

In an embodiment, adapter 205 may receive a request from Y app server 203 formatted according to a first protocol. Adapter 205 may transform or abstract the received request such that it may be serviced by system 201. For example, adapter 205 may transform or abstract the received request so that web service 210 may reply to the request. In an embodiment, adapter 205 may transform or abstract the received request that is formatted according to a first protocol such that the transformed or abstracted request is formatted according to a second protocol, and web service 210 may be configured such that the web service may reply to a request formatted according to the second protocol.

In an embodiment, interface 207 may communicate with adapter 205 such that the requests may be routed within system 201. For example, interface 207 may receive the transformed or abstracted request from adapter 205 and route it to engine 208.

In an embodiment, engine 208 may comprise a plurality of additional elements (not depicted) such that routing may be performed within system 201, as described above. Engine 208 may route the request such that it may be serviced by system 201. In an embodiment, engine 208 may route to request to web service 210.

In an embodiment, web service 210 may reply to the request. For example, web service 210 may comprise an application programming interface (API), and the request may comprise an API call. Accordingly, web service 210 may reply to the API call. The reply may be formatted according to the second protocol. In an embodiment, the reply may be routed through system 210, via engine 208 and interface 207 back to adapter layer 206. The reply may be routed to the particular one of the adapters that is configured to transform or abstract the reply back to an original protocol for the request. For example, the reply may be routed to adapter 205. Adapter 205 may abstract or transform the reply such that the reply is formatted according to the first protocol. Adapter 205 may then send the transformed or abstracted reply to Y app server 203. In an embodiment, the first and second protocols may be different, and may comprise any suitable protocols.

In an embodiment, the process of FIG. 3 may be performed, and a software module may be deployed, without interrupting a running software service. For example, Engine 208 of FIG. 2 may be running a software service, and may begin implementing the process of FIG. 3 while running the service. After executing the process of FIG. 3, engine 208 may deploy a software module, such as adapter 205, without resetting the service and with no down time. For example, the .jar file, or .far file, may be configured along with the real-time class loader to deploy a software module without requiring any down time for engine 208. In an embodiment, engine 208 may be running a java virtual machine (JVM) a software module, such as adaptor 205, may be deployed without interrupting or restarting the running JVM. In an embodiment, engine 208 may be running a routing and request servicing software service, as described above, while performing the process of FIG. 3.

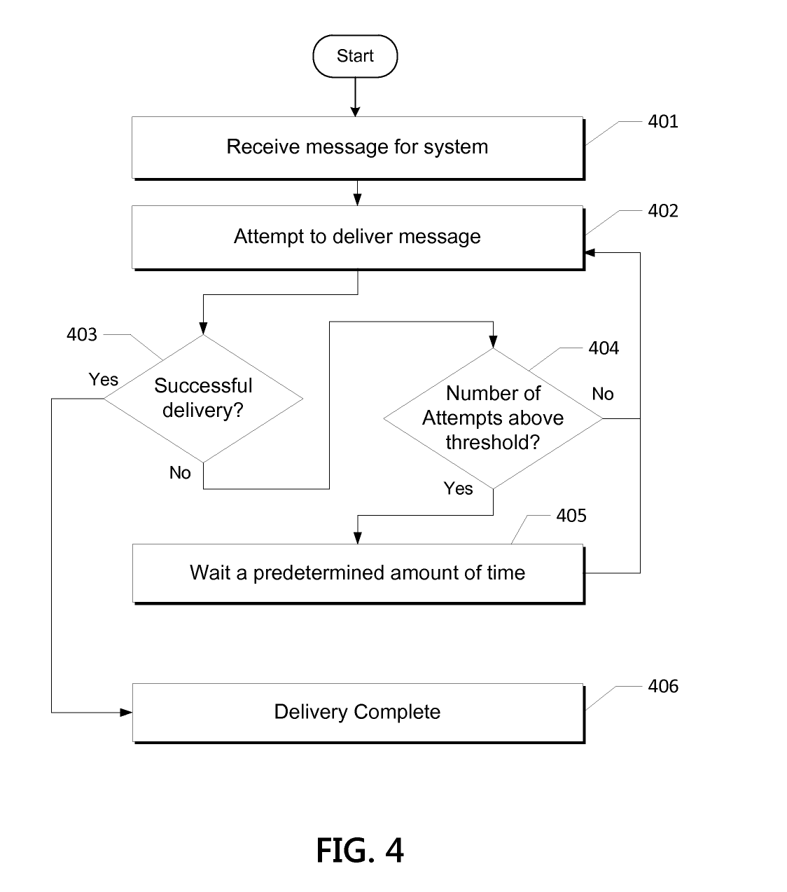

In an embodiment, the framework illustrated in FIG. 2 may perform guaranteed message delivery. FIG. 4 illustrates an example method for guaranteed delivery in accordance with an embodiment. The process of FIG. 4 may start at step 401, where a message for a system is received. For example, a message may be received at system 201 for a component of engine 208. The process of FIG. 4 may progress from step 401 to step 402, where a delivery of the message is attempted. For example, a delivery may be attempted to a component of engine 208. The process of FIG. 4 may progress from step 402 to step 403, where it is determined whether delivery was successful. If delivery of the message was successful, the process of FIG. 4 may progress from step 403 to step 406, where delivery is complete.

If delivery of the message was not successful, the process of FIG. 4 may proceed from step 403 to step 404, where it is determined whether a number of attempts is above a threshold. If a number of attempts is not above a threshold, the process of FIG. 4 may proceed back to step 402, where a delivery of the message is again attempted. Where delivery is not successful, the process of FIG. 4 may cycle through steps 402, 403 and 404. Accordingly, a number of attempts may be incremented at each cycle. At step 404, when the number of attempts is greater than a threshold, the process of FIG. 4 may progress to step 405, where the process waits for a predetermined amount of time prior to attempting another delivery. The predetermined amount of time may comprise minutes, hours, days, or any suitable amount of time. After the predetermined amount of time, the process of FIG. 4 may proceed from step 405 to step 402, where delivery of the message is again attempted. In an example, when the method progresses from step 405 to step 402, the number of attempts is reset. The process of FIG. 4 may proceed as described above until delivery is complete.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable memory. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A computer implemented method, comprising:
running, at a computing device, a software service, wherein the software service comprises a web service;
receiving a request to deploy a software module for the software service;
retrieving a binary file from a database, wherein the binary file is associated with the software module;
accessing a real-time class loader, wherein the real-time class loader is configured to dynamically load the binary file while the software service is running; and
deploying, by the real-time class loader, the software module using the retrieved binary file, wherein the deploying takes place while the software service is running; and
running, after the deploying, the software service such that the software service comprises the deployed software module.

2. A method of claim 1, wherein the retrieved binary file comprises a java archive (.jar) file.

3. A method of claim 1, wherein the retrieved binary file comprises a .far file and the .far file includes deployment descriptor, wherein the deployment descriptor is unique to a framework for the software service.

4. A method of claim 1, wherein deploying the software module is accomplished without restarting the software service.

5. A method of claim 1, wherein the received request to deploy a software module is received from a user interface.

6. A method of claim 1, wherein receiving a request to deploy a software module further comprises:
receiving a request for the software service, wherein the request is formatted according to a protocol;
determining that an adapter for the protocol is not available; and
requesting a software module that comprises an adapter for the protocol.

7. A method of claim 1, wherein running a software service includes running a java virtual machine, and wherein deploying the software module is accomplished without resetting the java virtual machine.

8. A method of claim 1,
wherein the received request to deploy a software module comprises a request to deploy an adapter for the software service and,
wherein the deployed software module comprises an adapter that is configured to handle a request formatted according to a first protocol.

9. A method of claim 8, wherein the adaptor is configured to transform or abstract a received request formatted according to the first protocol such that the transformed or abstracted request is formatted according to a second protocol.

10. A method of claim 8, further comprising:
receiving, at the deployed software module, a request formatted according to the first protocol;
modifying the request such that it is formatted according to a second protocol, wherein the modifying may comprise one of abstracting or transforming the request;
routing the modified request to the software service;
receiving a reply from the software service formatted according to the second protocol;
modifying the reply such that it is formatted according to the first protocol, wherein the modifying may comprise one of abstracting or transforming the reply; and
sending the modified reply to a computing device.

11. A system comprising:
a first computing device, with a processor, configured to:
run a software service, wherein the software service comprises a web service;
receive a request to deploy a software module for the software service;
retrieve a binary file from a database, wherein the binary file is associated with the software module;
access a real-time class loader, wherein the real-time class loader is configured to dynamically load the binary file, wherein the deploying takes place while the software service is running; and
deploy, by the real-time class loader, the software module using the retrieved binary file while the software service is running; and
run, after the deploying, the software service such that the software service comprises the deployed software module.

12. A system of claim 11, wherein the retrieved binary file comprises a java archive (.jar) file.

13. A system of claim 11, wherein the retrieved binary file comprises a .far file and the .far file includes deployment descriptor, wherein the deployment descriptor is unique to a framework for the software service.

14. A system of claim 11, wherein deploying the software module is accomplished without resting the software service.

15. A system of claim 11, wherein the received request to deploy a software module is received from a user interface.

16. A system of claim 11, wherein receiving a request to deploy a software module further comprises:
receiving a request for the software service, wherein the request is formatted according to a protocol;
determining that an adapter for the protocol is not available; and
requesting an adapter for the protocol.

17. A system of claim 11, wherein running a software service includes running a java virtual machine, and wherein deploying the software module is accomplished without resetting the java virtual machine.

18. A system of claim 1,
wherein the received request to deploy a software module comprises a request to deploy an adapter for the software service and,
wherein the deployed software module comprises an adapter that is configured to handle a request formatted according to a first protocol.

19. A system of claim 18, wherein the first computing device is further configured to:
receive, at the deployed software module, a request formatted according to a first protocol;
modify the request such that it is formatted according to a second protocol, wherein the modifying may comprise one of abstracting or transforming the request;
route the modified request to the software service;
receive a reply from the software service formatted according to the second protocol;
modify the reply such that it is formatted according to the first protocol, wherein the modifying may comprise one of abstracting or transforming the reply; and
send the modified reply to a computing device.

20. One or more non-transitory computer readable media having stored thereon instructions that, when executed by an apparatus, cause the apparatus to:
run a software service, wherein the software service comprises a web service;
receive a request to deploy a software module for the software service;
retrieve a binary file from a database, wherein the binary file is associated with the software module;
access a real-time class loader, wherein the real-time class loader is configured to dynamically load the binary file while the software service is running; and
deploy, by the real-time class loader, the software module using the retrieved binary file, wherein the deploying takes place while the software service is running; and
run, after the deploying, the software service such that the software service comprises the deployed software module.
